(19) United States
(12) Patent Application Publication
(10) Pub. No.: US 2026/0241415 A1
(43) Pub. Date: Aug. 20, 2026

(54) Material processing device having a screening unit

(71) Applicant: Kleemann GmbH, Göppingen (DE)

(72) Inventors: Benjamin Kazmaier, Owen (DE); Tobias Geywitz, Eislingen (DE); Tobias Klöss, Bad Grönenbach (DE)

(21) Appl. No.: 19/532,562

(22) Filed: Feb. 6, 2026

(30) Foreign Application Priority Data
Feb. 19, 2025 (DE) 10 2025 106 319.2

(51) Int. Cl. B07B 1/00

(52) U.S. Cl. CPC B07B 1/005; B07B 2201/04

(57) ABSTRACT

A material processing device includes a screening unit having an upper screen deck and at least one lower screen deck. A discharge conveyor is configured to remove a screen fraction from a working area of the screening unit when the discharge conveyor is in a lateral discharge position. An adjusting device is configured to move the discharge conveyor between the lateral discharge position and a mixing position. A mixing arrangement is configured to mix at least part of the screen fraction conveyed by the discharge conveyor with a further screen fraction of the screen unit when the discharge conveyor is in the mixing position.

### RELATED APPLICATION

The present application claims priority to German Patent Application Ser. No. DE 10 2025 106 319.2, filed Feb. 19, 2025, which is incorporated herein by reference.

### BACKGROUND OF THE DISCLOSURE

### Field of the Disclosure

The disclosure relates to a material processing device used, for instance, to classify rock material or demolition material from a construction site. For this purpose, material to be processed is fed into the plant. The screening unit is used to screen various screen fractions from this material.

The material processing device can be a stationary or mobile work unit. It can be part of a larger plant configuration, for instance in the form of a secondary screening unit in combination with a mineral material crusher. The mineral material crusher can be a jaw crusher, a rotary impact crusher, a cone crusher or any other type of crusher.

### Description of the Prior Art

A screening unit, which has several screen linings disposed one above the other in a screen tray, is known from EP 4 076 774 B1. A grain fraction is screened out of the material to be processed at each screen lining. Plates having closable openings are used to extended the screen decks. If the openings of the closable plates are unblocked, a screen fraction transported on a screen lining can be mixed with a screen fraction from a screen lining below. In this way, mixed fractions can be created that can be used for specific applications.

To be able to produce these mixed fractions, a complex conversion of the plant is required. In addition, a user has to enter the danger zone of the machine, which should be avoided.

### SUMMARY OF THE DISCLOSURE

The disclosure addresses the problem of providing a material processing device of the type mentioned at the beginning, which can be used to produce mixed fractions from the individual screen fractions in a simple manner.

This problem is solved in that a movable discharge conveyor can be moved between a lateral discharge position and a mixing position by means of an adjusting device, and in that in the mixing position at least part of the screen fraction conveyed by the discharge conveyor is mixed with a further screen fraction by means of a mixing arrangement.

Using this design the production of mixed fractions is extremely simple. To mix the screen fractions as required, the discharge conveyor simply needs to be moved into the mixing position using the adjusting device, which can be done without great effort. In particular, no longer an operator has to enter the danger zone of the machine, but the operator can adjust the discharge conveyor as required from a protected environment. If the production of a mixed fraction is no longer desired, the user can return the discharge conveyor to its lateral discharge position. The screen fraction conveyed on the discharge conveyor can then be deposited on a stockpile laterally of the machine.

A preferred variant of the disclosure is such that the discharge conveyor receives a medium-grain fraction screened out below an upper screen deck and mixes this with the further screen fraction screened out below a second screen deck. The first screen fraction can be the screen fraction that is discharged on the upper screen deck or that preferably accumulates below the upper screen deck.

The other screen fraction may be the screen fraction that has fallen through the second screen deck. It can also be a screen fraction that has fallen through the second screen deck and through at least one further screen deck disposed below the second screen deck.

According to a further preferred variant of the disclosure, provision may be made for a swivel device to be provided, by means of which the discharge conveyor can be swiveled about a substantially vertically oriented first swivel axis for movement from the first lateral discharge position, for the discharge conveyor to be coupled to a height adjuster, and for the height position of at least the end discharge area of the discharge conveyor to be movable by means of the height adjuster in the direction of gravity or in the opposite direction to the direction of gravity to bring the mixing arrangement into the mixing position. In this way, the mixing arrangement can be positioned with little effort and without extensive conversion work.

To guarantee an orderly transfer of the screen fraction from the screening unit to the discharge conveyor, provision may be made for an endless circulating conveyor belt of a feed device to be disposed between the screening unit and the discharge conveyor in the conveying direction, for the conveying direction of the feed device to extend transverse to the conveying direction of the screening unit, and for the feed device to form a transfer area at its discharge end, which transfer area is assigned to a feed area of the discharge conveyor.

The mixing function can be implemented by simple means if provision is made for the conveyor arrangement of the discharge conveyor to have an endless circulating conveyor belt, which extends between a feed area at the feed end and a discharge area at the end in the conveying direction, and for a catch arrangement of the mixing arrangement to be disposed in the discharge area. The catch arrangement can be funnel-shaped, for instance, to make for a good material transfer.

According to the disclosure, provision may preferably be made for the mixing arrangement to be attached to the discharge conveyor, or for the mixing arrangement to be attached to a conveyor transporting the further screen fraction, or for the mixing arrangement to be attached to the screening unit. If the mixing arrangement is disposed on the discharge conveyor, it can be moved particularly advantageously and easily into the position assigned to the mixing position in conjunction with the discharge conveyor.

According to a variant of the disclosure, provision may be made for the mixing arrangement to have a chute, by means of which the screen fraction transported by the discharge conveyor is fed directly or indirectly to the further screen fraction. The transfer of the screen fraction coming from the discharge conveyor to the chute can be achieved by the effect of gravity. This means that the mixing arrangement can preferably do without a motor-driven conveyor.

However, it is also conceivable that the mixing arrangement has an endless circulating conveyor belt by means of which the screen fraction transported by the discharge conveyor is fed directly or indirectly to the further screen fraction. Such a conveyor belt of the mixing arrangement can be used in addition to or as an alternative to the chute mentioned above.

A particularly preferred variant of the disclosure is such that the discharge conveyor can be swiveled into a transport position by means of the adjusting device, wherein the discharge conveyor is folded laterally against a screen tray or the supporting frame of a screen tray of the screening device. This allows the discharge conveyor to be moved to a third position, namely the transport position, in addition to the lateral discharge position and the mixing position. The adjusting device can easily access these three different positions.

In the transport position, the discharge conveyor can be folded laterally against the screen tray and also rotated about its longitudinal axis to be positioned at the side of the screening unit in a space-saving manner. This is particularly advantageous if the discharge conveyor has an endless circulating conveyor belt as a transport device. Preferably, the adjusting device is designed in such a way that the discharge conveyor, starting from the lateral discharge position or the mixing position, is folded laterally against the screening unit and is also rotated about its longitudinal axis during this motion or at least during part of this motion sequence. This renders moving the discharge conveyor into the transport position in a short time possible.

A particularly resilient design results if provision is made for the adjusting device to comprise an actuator that can swivel about a swivel axis to move the discharge conveyor from the lateral discharge position into its mixing position and/or into its transport position, for the actuator to be coupled to a holder via at least one tension means, and for the holder to be attached to the discharge conveyor in the area between the feed area and the discharge area, spaced apart from the actuator at the discharge conveyor. This means that at least part of the weight of the discharge conveyor can be safely transferred via the tension means.

A material processing device according to the disclosure can preferably be such that a fine-grain conveyor is connected to the screening unit, which fine-grain conveyor has an endless circulating conveyor belt having a conveying area, that the conveying area forms a feed area assigned to the screening unit and a discharge area facing away from the screening unit, and that the mixing arrangement feeds the screen fraction routed by the discharge conveyor to the further screening fraction routed on the fine-grain conveyor.

A space-saving design can be implemented if provision is made for the conveying directions of the fine-grain conveyor and the discharge conveyor in the mixing position to extend in the opposite or substantially opposite direction to the conveying direction of the screening unit.

It is particularly preferred for the feed area of the fine-grain conveyor to be disposed below the lower screen deck of the screening unit. This means that the finest screen fraction can be removed from the fine-grain conveyor and mixed with the screen fraction coming from the discharge conveyor. Such a mixture of screen fractions can preferably be used in the construction industry to increase the purity and thus the quality of the end product.

A possible variant of the disclosure can be such that a wind sifter is disposed between the screening unit and the discharge conveyor in the conveying direction, which wind sifter acts on the screen fraction fed to the discharge conveyor or routed on the discharge conveyor. In this way, unwanted impurities in the screen fraction can be removed to provide a screen fraction that is as pure as possible. The wind sifter can have a fan that acts on the feed area to the discharge conveyor or on the discharge conveyor itself. The air flow of the wind sifter can be adjusted to blow unwanted lighter particles or at least some of these lighter particles out of the volume flow of the discharge conveyor.

A wind sifter can be used to clean the medium grain before it is combined with the fine grain. This allows light materials that are otherwise contained in the end product to be sorted out.

### BRIEF DESCRIPTION OF THE DRAWINGS

The disclosure is explained in greater detail below based on an exemplary embodiment shown in the drawings. In the figures,

FIG. 1 shows a perspective view of a material processing device having a crusher and a screening unit,

FIG. 2 shows an enlarged view of the screening unit of FIG. 1,

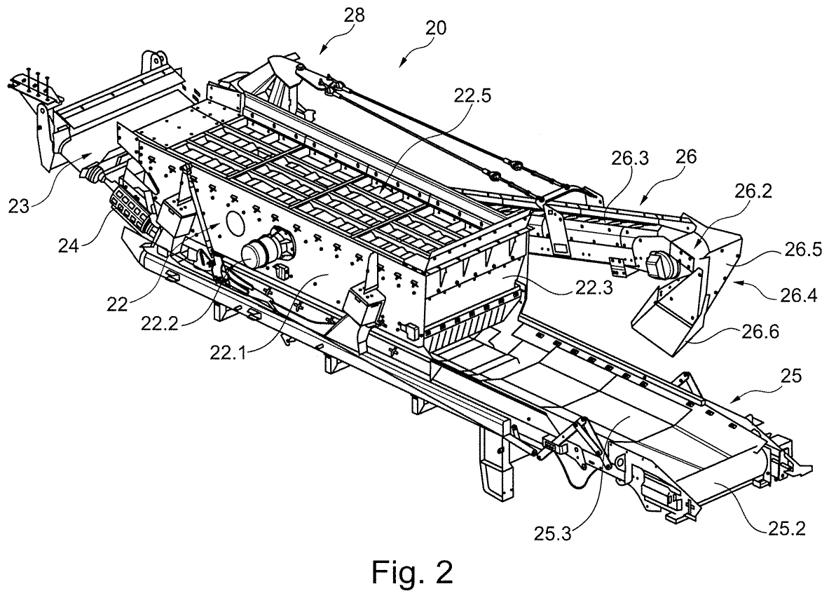

FIG. 3 shows a side view from the left of the screening unit of FIG. 2,

FIG. 4 shows a top view of the screening unit of FIGS. 2 and 3, and

FIG. 5 shows the screening unit of FIGS. 2 to 4 along the cutting path marked V-V in FIG. 4.

### DETAILED DESCRIPTION

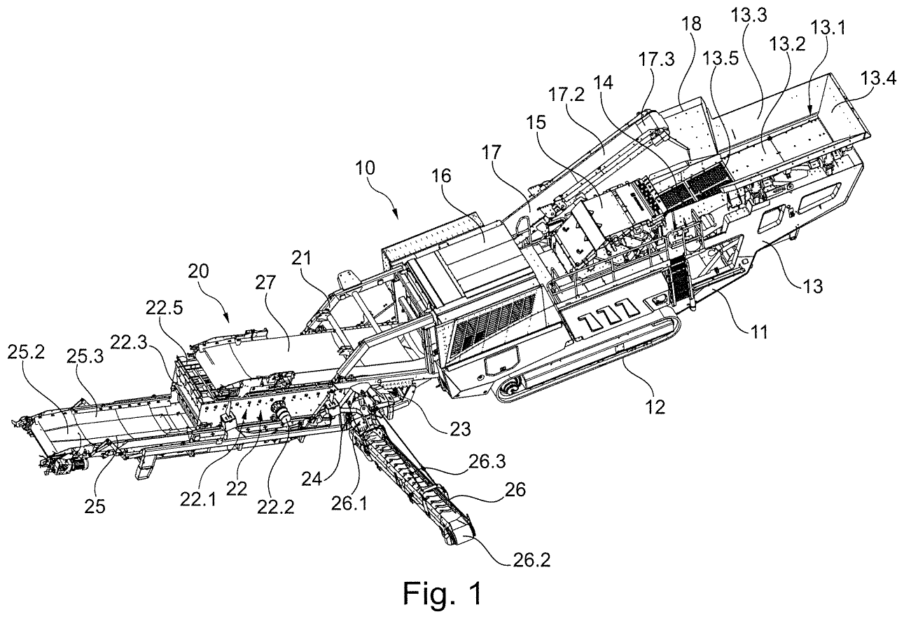

FIG. 1 shows a material processing device 10 having a crusher and a screening unit 20 attached thereto. The material processing device 10 can be designed in particular as a mobile material processing device 10. It can therefore have an undercarriage 12. However, it is also conceivable that the material processing device 10 is a stationary material processing device 10.

The material processing device 10 has a machine undercarriage 11 bearing the machine components or at least a part of the machine components. The machine undercarriage 11 may have a boom at its rear end. A feed device 13 is formed in the area of the boom.

The feed device may have a feed hopper 13.1, which is at least partially formed by hopper side casings 13.3 and a rear hopper casing 13.4.

A material feed area is formed in the area of the feed hopper 13.1. This material feed area has a conveyor device, which can take the form of a conveyor chute 13.2. The conveyor chute 13.2 can be driven by a vibratory drive. The feed hopper 13.1 can be used to feed material to be comminuted into the material processing device 10, for instance using a wheel loader, and to feed it onto the conveyor chute 13.2.

Preferably, the material to be comminuted passes from the conveyor chute 13.2 into the area of a pre-screen arrangement 14 via a transition area 13.5. At least one screen deck is disposed in the area of the pre-screen arrangement 14; for instance, two screen decks disposed one above the other can be used.

A system configuration in which no pre-screen arrangement 14 is used is also conceivable.

A partial fraction of the material to be comminuted is screened on the upper screen deck of the pre-screen arrangement 14. This partial fraction already has a sufficient particle size that it no longer needs to be comminuted in the material processing device 10. In this respect, this screened partial fraction can be transported in a bypass channel past a crushing unit of the crushing device 15.

If a second screen deck is used in the pre-screening unit 14, a further fine-particle fraction can be screened from the partial fraction that accumulates below the upper screen deck. This fine-particle fraction can be discharged laterally of the machine by means of a lateral discharge belt.

The material to be comminuted coming from the upper screen deck is fed to the crushing device 15. The crushing device 15 has a crushing unit, for instance in the form of an impact crusher unit, in particular a rotary impact crusher unit, a jaw crusher unit, a cone crusher unit or a roller crusher unit.

FIG. 1 shows that the machine undercarriage 11 bears a drive 16, which is used, among other things, to drive the crushing device 15. Additionally or alternatively, provision may be made for the drive 16 to be used to drive the pre-screen arrangement 14 and/or the screening unit 20.

The material to be comminuted is comminuted in the crushing device 15. The material to be comminuted can be conveyed to the screening unit 20 via a transport device, in particular a discharge chute and/or an endless circulating conveyor belt. The screening unit 20 can therefore also be referred to as a post-screening device.

A feed device 27 is used to feed the material coming from the crushing device 15 to the screening unit 20. The feed device 27 can be a belt conveyor having an endless circulating conveyor belt. This conveyor belt has a slack side and a tight side. The slack side is used to collect the crushed material and transport it away from the crushing device 15. At the belt ends, deflection rollers can be used to deflect the conveyor belt from the slack side to the tight side and vice versa. Guides, in particular support rollers, can be provided in the area between the deflection rollers to change the direction of conveyance of the conveyor belt, to shape the conveyor belt in a certain way and/or to support the conveyor belt. The belt conveyor has a belt drive, for instance a hydraulic motor or an electric motor, which can be used to drive the belt conveyor. The belt drive can preferably be located at the discharge end of the belt conveyor.

One or more further belt conveyors may be used, which in principle have the same design as the belt conveyor of the feed device 27 described above. In this respect, reference can be made to the above statements. The other belt conveyors can be a coarse-grain conveyor 23, a feed device 24, a fine-grain conveyor 25, a discharge conveyor 26 or a return conveyor 17. These structural units are referred to in more detail below.

The screening unit 20 can be detachably attached to the machine undercarriage 11, for instance at least by means of a bracket 21.

The screening unit 20 has a screen tray 22, which is laterally delimited in the longitudinal direction of the machine by two lateral screen casings 22.1. At its free end, the screen tray 22 is delimited by a rear screen casing 22.3.

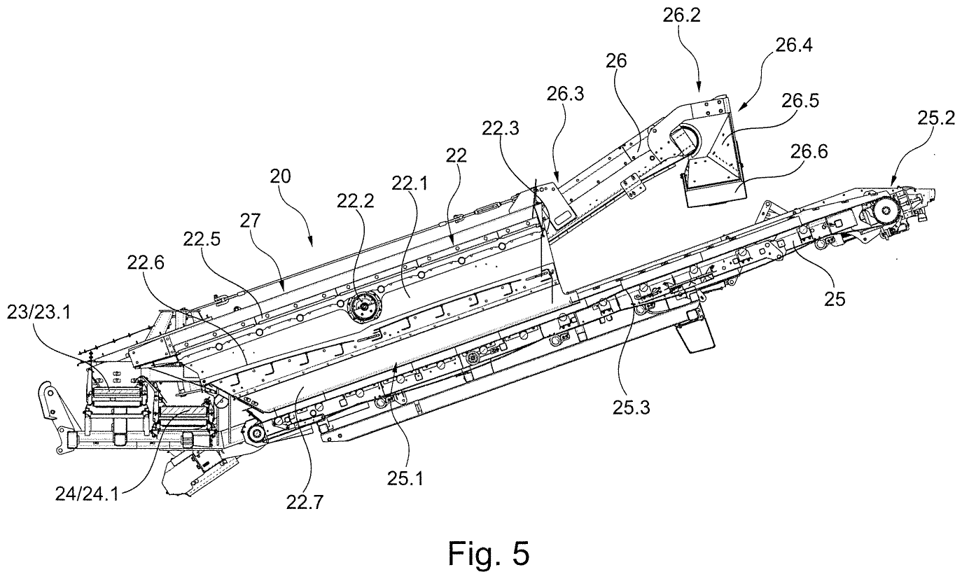

The structure of the screening unit 20 can be seen in more detail in FIG. 5. As this diagram illustrates, the screening unit 20 has the screen housing, which is formed by the screen tray 22. At least one screen deck is disposed in the screen housing. In this exemplary embodiment, an upper screen deck 22.5 and at least one subjacent second screen deck 22.6 are used. The second screen deck 22.6 may also be referred to as a lower screen deck 22.6. Below the lowest screen deck 22.6, a lower housing part is formed, which is used as a collection chamber 22.7 for the material screened at the lower screen deck 22.6.

The lower part of the housing creates a spatial connection to the fine-grain conveyor 25 via an opening. There, the fine-grain-conveyor 25 forms its feed area 25.1, wherein the screened material in the feed area 25.1 is directed onto the slack side of the fine-grain conveyor 25. The fine-grain conveyor 25 conveys the screened material to its discharge area 25.2. From there, the screened material is transferred to a pile.

The material not screened out at the upper screen deck 22.5 of the screening unit 20 is conveyed from the upper screen deck 22.5 to a coarse-grain feed area 23.1 of the coarse-grain conveyor 23. In FIG. 5, the transport direction of the coarse-grain conveyor 23 extends in the direction of the image depth.

At its discharge end, the coarse-grain conveyor 23 transfers the un-screened material, also referred to as oversize material, to a feed area 17.1 of the return conveyor 17. The return conveyor 17 conveys the oversize grain by means of its conveyor belt 17.2 in the direction of the feed hopper 13.1. At its discharge end 17.3, the return conveyor 17 transfers the oversize grain into the material flow, in particular into the material feed area in front of the crushing device 15. The oversize material can therefore be returned to the crusher unit 15 and crushed to the desired particle size.

The material screened from the upper screen deck 22.5 falls onto the second screen deck 22.6. The material that is not screened by the second screen deck 22.6 can also be referred to as the medium grain. The screening unit 20 conveys this medium grain to a medium-grain feed area 24.1 of the feed device 24. In FIG. 5, the conveying direction of the feed device 24 extends in the direction of the image depth, i.e. transverse to the conveying direction of the screening unit 20.

The medium grain is conveyed to a feed area 26.1 of the discharge conveyor 26. FIG. 1 shows the discharge conveyor 26 more clearly. As this diagram illustrates, the discharge conveyor 26 has a conveyor arrangement 26.3 downstream of the feed area 26.1, which conveyor arrangement leads to a discharge area 26.2.

The discharge conveyor 26 is swivel-coupled to the screening unit 20 by means of an adjusting device 28. The adjusting device 28 may have a first bearing arrangement, which forms a swivel device 28.4. The swivel device 28.4 can be designed in such a way that the discharge conveyor 26 can be swiveled laterally from the lateral discharge position shown in FIG. 1 in the direction of the lateral screen casing 22.1 of the screen tray 22. The discharge conveyor may be coupled to the screening unit 20 by means of the swivel device 28.4 for it to be able to swivel about a substantially vertical swivel axis.

As the drawings illustrate, the adjusting device 28 may have a height adjuster 28.6. The height adjuster 28.6 is designed to move the height orientation of at least the discharge area 26.2 of the discharge conveyor 26. In this way, the height of the discharge area 26 can be adjusted to the height of the stockpile in the lateral discharge position shown in FIG. 1. The height adjuster 28.6 of the adjusting device 28 may have a second bearing unit by means of which the discharge conveyor 26 can be swiveled about a substantially horizontal axis.

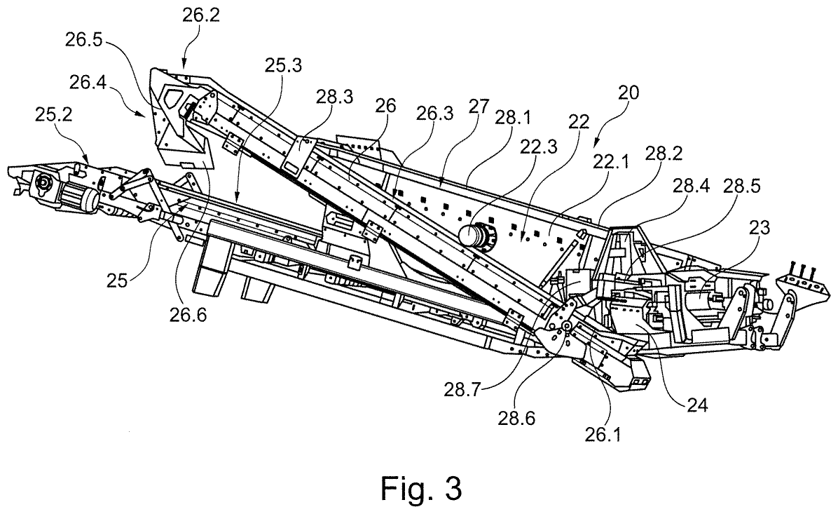

FIG. 3 illustrates that the adjusting device 28 may have a swivel actuator 28.5 to move the swivel position of the discharge conveyor 26. The swivel actuator 28.5 can be a hydraulic cylinder.

Additionally or alternatively, provision may be made for an actuator 28.7 to be assigned to the height adjuster 28.6 to change the height alignment of at least the ejection area 26.2. The actuator 28.7 may be a hydraulic cylinder.

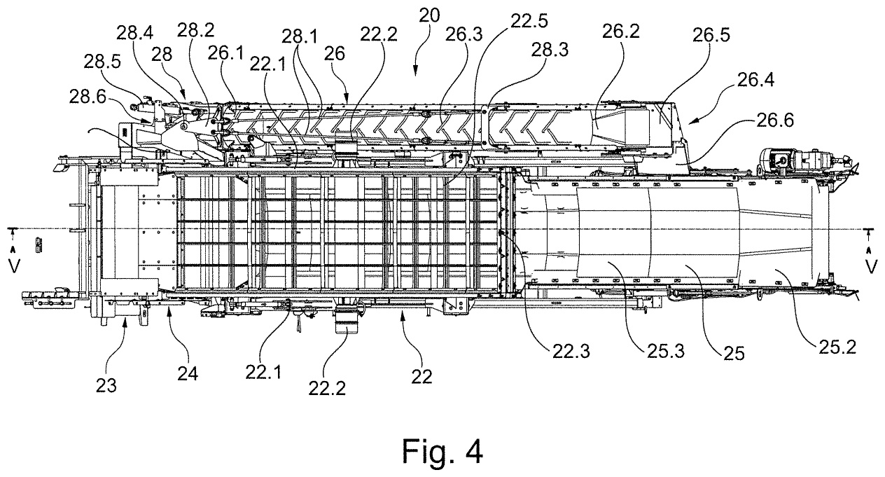

FIG. 4 illustrates that advantageously the swivel device 28.4 may have an actuator 28.2. The actuator 28.2 can preferably be swiveled about the swivel axis of the swivel device 28.4. The actuator 28.2 is coupled to at least one tension means 28.1. At the end area facing away from the actuator 28.2, the tension means 28.1 are coupled to a holder 28.3. The holder 28.3 is coupled to the conveyor arrangement 26.3 offset in the direction of the discharge area 26.2 towards the feed area 26.1. This means that the weight of the discharge conveyor 26 can be transferred via the tension means 28.1.

FIGS. 3 and 4 illustrate that the discharge conveyor 26 can be moved to a mixing position by means of the adjusting device 28. As FIG. 4 illustrates, the conveying direction of the discharge conveyor 26 extends in the direction or substantially in the direction of the longitudinal extent of the screening unit 20.

As shown in the drawings, a mixing arrangement 26.4 can be attached to the discharge conveyor 26 in the discharge area 26.2. The mixing arrangement 26.4 has a catch arrangement 26.5. The catch arrangement 26.5 is designed and disposed to catch at least part of the material conveyed by the discharge conveyor 26. The catch arrangement 26.5 can be at least partially formed by a funnel-shaped body. The mixing arrangement 26.4 may also be referred to as a mixing conduit 26.4.

The catch arrangement 26.5 may have a deflection device, which can be used to change the conveying direction of the goods.

As the figures illustrate, the mixing arrangement 26.4 has a transfer section downstream of the catch arrangement 26.5, which can be used to discharge the material caught by the catch arrangement 26.5, at least partially, from the working area of the discharge conveyor 26. In this exemplary embodiment, the transfer section is formed like a chute 26.6. By means of the chute 26.6, the material of the discharge conveyor can be discharged from the working area of the discharge conveyor 26 under the effect of gravity.

As the figures illustrate, the mixing arrangement 26.4 may be disposed and held in such a way that it feeds the material from the discharge conveyor 26 to the fine-grain conveyor 25.

For instance, the medium grain of the discharge conveyor 26 is mixed with the fine grain of the fine-grain conveyor 25. The mixed material is then conveyed to the discharge area 25.2 via the conveying area 25.3 of the fine-grain conveyor 25. From there, the mixed material can then be removed from the working area of the screening unit 20.

In this exemplary embodiment, the mixing arrangement 26.4 is mounted on the discharge conveyor 26 and can be moved in conjunction therewith by means of the adjusting device 28.

It is also conceivable that the mixing arrangement 26.4 or the catching arrangement 26.5 is attached to another component of the screening unit 20, for instance to the fine-grain conveyor 25. The catch arrangement 26.5 is then positioned to pick up the material of the discharge conveyor 26, at least partially, from the discharge area 26.2. The material is then conveyed to the fine-grain conveyor 25 via the transfer device, for instance the chute 26.6.

A further embodiment can be such that the discharge conveyor 26 can be rotatable about its central longitudinal axis extending in the conveying direction. Thus, in addition to the laterally folded mixing position shown in FIG. 4, the discharge conveyor 26 can also be rotated about its central longitudinal axis to bring the discharge conveyor 26 into a space-saving transport position. In this transport position, the discharge conveyor 26 is folded laterally of the screen tray 23 and rotated about its central longitudinal axis.

To move the discharge conveyor 26 from the lateral discharge position shown in FIG. 1 to the mixing position shown in FIG. 4, the swivel device 28.4 folds the discharge conveyor 26 laterally against the screen tray 22 such that it assumes the swivel position shown in FIG. 4. Then, the height adjuster 28.6 can change the height orientation of the discharge area 26.2 such that the mixing arrangement 26.4 is brought into its mixing position, in which the chute 26.6 is assigned to the conveying area 25.3 of the fine-grain conveyor.

When the discharge conveyor 26 is in its mixing position, the medium grain is fed from the screening unit 20 to the discharge conveyor 26, for instance via the feed device 24. The discharge conveyor 26 transfers the conveyed material to the mixing arrangement 26.4. The mixing arrangement 26.4 routes the material to the conveying area 25.3. There, the material from the discharge conveyor 26 is mixed with the material from the fine-grain conveyor.

If the mixing process is to be completed, the discharge conveyor is returned to the lateral discharge position shown in FIG. 1.

To move the discharge conveyor 26 into its transport position, the swivel device 28.4 folds it laterally from its lateral discharge position (FIG. 1) against the screen tray 22.

In addition, according to one variant, provision may be made for the discharge conveyor 26 to be rotated, superimposed on the swivel movement, preceding the swivel movement, or in succession of the swivel movement, about its central longitudinal axis to position it laterally of the screen tray 22 in a space-saving manner.

It is also conceivable that the discharge conveyor 26 is first moved to its laterally folded position against the screen tray 22 and then rotated about its central longitudinal axis.

Thus, in its transport position, the discharge conveyor 26 is aligned laterally of the screen tray 22 in the direction of the longitudinal extent of the screening unit 20 to save space.

1-14. (canceled)

15. A material processing device, comprising:
a screening unit including an upper screen deck and at least one lower screen deck disposed below the upper screen deck in a direction of gravity;
a discharge conveyor configured to remove a screen fraction from a working area of the screening unit when the discharge conveyor is in a lateral discharge position, the discharge conveyor including a motor-driven conveyor;
an adjusting device configured to move the discharge conveyor between the lateral discharge position and a mixing position; and
a mixing arrangement configured to mix at least part of the screen fraction conveyed by the discharge conveyor with a further screen fraction of the screen unit when the discharge conveyor is in the mixing position.

16. The material processing device of claim 15, wherein:
the screen fraction removed by the discharge conveyor is a medium-grain fraction screened out below the upper screen deck; and
the further screen fraction is screened out below the lower screen deck.

17. The material processing device of claim 15, wherein:
the discharge conveyor is swivel mounted relative to the screening unit so that the discharge conveyor may be swiveled about a first swivel axis from the lateral discharge position towards the mixing position; and
the material processing device further includes a height adjuster configured to adjust a height of at least a discharge end of the discharge conveyor to bring the mixing arrangement into the mixing position.

18. The material processing device of claim 15, further comprising:
a feed conveyor disposed between the screening unit and the discharge conveyor, the feed conveyor having a feed conveyor conveying direction extending transverse to a conveying direction of the screening unit, the feed conveyor including an endless circulating conveyor belt having a discharge end arranged to transfer material onto the discharge conveyor.

19. The material processing device of claim 15, wherein:
the discharge conveyor includes an endless circulating conveyor belt extending from a feed end to a discharge end; and
the mixing arrangement includes a catch arrangement configured to receive material from the discharge end of the discharge conveyor.

20. The material processing device of claim 15, wherein:
the mixing arrangement is attached to the discharge conveyor.

21. The material processing device of claim 15, wherein:
the mixing arrangement is attached to a conveyor transporting the further screen fraction.

22. The material processing device of claim 15, wherein:
the mixing arrangement is attached to the screening unit.

23. The material processing device of claim 15, wherein:
the mixing arrangement includes a chute configured to transport the screen fraction from the discharge conveyor directly or indirectly to the further screen fraction.

24. The material processing device of claim 15, wherein:
the mixing arrangement includes an endless circulating conveyor belt configured to transport the screen fraction from the discharge conveyor directly or indirectly to the further screen fraction.

25. The material processing device of claim 15, wherein:
the adjusting device is configured to swivel the discharge conveyor into a transport position wherein the discharge conveyor is folded laterally against a screen tray of the screening unit.

26. The material processing device of claim 15, wherein:
the adjusting device includes an actuator configured to swivel about a swivel axis to move the discharge conveyor from the lateral discharge position into the mixing position, wherein the actuator is coupled to the discharge conveyor by at least one tension device connected to a holder attached to the discharge conveyor between a feed end and a discharge end of the discharge conveyor.

27. The material processing device of claim 15, further comprising:
a fine grain conveyor connected to the screening unit, the fine grain conveyor including an endless circulating conveyor belt having a feed area for receiving material from the screening unit and having a discharge area facing away from the screening unit;
wherein the mixing arrangement is configured to feed the screen fraction routed by the discharge conveyor to the further screen fraction routed on the fine grain conveyor.

28. The material processing device of claim 27, wherein:
a conveying direction of the fine grain conveyor and a conveying direction of the discharge conveyor in the mixing position extend opposite to a conveying direction of the screening unit.

29. The material processing device of claim 27, wherein:
the feed area of the fine grain conveyor is disposed below the second screen deck of the screening unit.

30. The material processing device of claim 15, further comprising:
a wind sifter disposed between the screening unit and the discharge conveyor and configured to act on the screen fraction fed to the discharge conveyor.

31. A material processing device, comprising:
a screening unit including an upper screen deck and at least one lower screen deck disposed below the upper screen deck in a direction of gravity;
a discharge conveyor configured to remove a screen fraction from a working area of the screening unit, the discharge conveyor being swivel mounted relative to the screening unit so that the discharge conveyor may be swiveled between the lateral discharge position and a mixing position;
an adjusting actuator configured to move the discharge conveyor between the lateral discharge position and the mixing position; and
a mixing conduit configured to mix at least part of the screen fraction conveyed by the discharge conveyor with a further screen fraction of the screen unit when the discharge conveyor is in the mixing position.

32. The material processing device of claim 31, wherein:
the screen fraction removed by the discharge conveyor is a medium-grain fraction screened out below the upper screen deck;
the material processing device further includes a fine grain conveyor arranged below the lower screen deck for receiving the further screen fraction as a fine-grain fraction screened out below the lower screen deck; and
the mixing conduit is configured to feed the medium-grain fraction routed by the discharge conveyor to the fine-grain fraction routed on the fine grain conveyor.

33. The material processing device of claim 32, wherein:
the mixing conduit includes a funnel for receiving the medium-grain fraction from the discharge conveyor and a chute for conducting the medium-grain fraction from the funnel to the fine grain conveyor.

34. The material processing device of claim 31, further comprising:
a height adjusting actuator configured to adjust a height of at least a discharge end of the discharge conveyor to bring the mixing conduit into the mixing position.
